(19) United States
(12) Patent Application Publication
(10) Pub. No.: US 2016/0350249 A1
(43) Pub. Date: Dec. 1, 2016

(54) DATA MANAGEMENT FOR ELECTRICAL AND FIBER OPTIC INTERFACES

(71) Applicant: Allied Telesis, Inc., San Jose, CA (US)

(72) Inventor: Douglas D. Barga, Bellevue, WA (US)

(21) Appl. No.: 14/726,321

(22) Filed: May 29, 2015

(51) Int. Cl. G06F 13/38; G06F 13/42; G06F 13/40

(52) U.S. Cl. CPC G06F 13/385; G06F 13/4068; G06F 13/426

(57) ABSTRACT

Some embodiments provide an apparatus that includes a first interface, a second interface, and a data management module. The first interface is configured for communicating data with a device coupled to the first interface. The second interface is configured for communicating data with an external environment of the apparatus. The first interface is different from the second interface. The data management module is configured for routing data between the device and the external environment via the first and second interfaces upon detecting that the device is coupled to the first interface.

### RELATED U.S. APPLICATIONS

This application is related to U.S. patent application Ser. No. 13/915,380 entitled “ADAPTER CARD FOR THIN COMPUTING DEVICES”, by Douglas D. Barga. (Attorney Docket No. 13-005-00-US) which is incorporated by reference herein in its entirety.

This application is related to U.S. patent application Ser. No. 14/538,662 entitled “ADAPTER CARD FOR THIN COMPUTING DEVICES”, by Douglas D. Barga. (Attorney Docket No. 13-053-00-US) which is incorporated by reference herein in its entirety.

This application is related to U.S. patent application Ser. No. 14/538,674 entitled “INTEGRATED ADAPTER FOR THIN COMPUTING DEVICES”, by Douglas D. Barga. (Attorney Docket No. 13-054-00-US) which is incorporated by reference herein in its entirety.

### BACKGROUND

Computing devices are used for a variety of different purposes. For example, many computing devices are used to communicate with other computing devices and/or electronic devices. Computing devices may have several of the same and/or different types of communication interfaces for communicating with computing devices and/or electronic devices.

### SUMMARY

Accordingly, a need has arisen to provide a computing device that routes data between different types of communication interfaces of the computing device. For example, there is a need to route data between an electrical communication interface and a fiber optic communication interface.

In some embodiments, an apparatus includes a first interface, a second interface, and a data management module. The first interface may be configured for communicating data with a device coupled to the first interface. The second interface may be configured for communicating data with an external environment of the apparatus. The first interface may be different from the second interface. The data management module may be configured for routing data between the device and the external environment via the first and second interfaces upon detecting that the device is coupled to the first interface.

In some embodiments, the apparatus further includes a motherboard that is configured for connecting the first and second interfaces. The first interface may be a copper-based interface integrated into the motherboard. In some embodiments, the apparatus further includes an adapter card that is configured for coupling to a motherboard interface of the motherboard. The first interface may include a copper-based interface integrated into the adapter card.

In some embodiments, the data communicated between the device and the external environment may belong to a first local area network (LAN) and data other than the data communicated between the device and the external environment may belong to a second, different LAN. The data management module may be further configured for operating at a layer 2 level of an operating system configured for executing on the apparatus, in some embodiments. It is appreciated that the second interface may be further configured for communicating data with the external environment via optical signals. It is also appreciated that the device may be configured for communicating voice data with the external environment. In some embodiments, the external environment includes a network.

In some embodiments, an apparatus includes an external interface, several interfaces, and a data management module. The external interface may be configured for communicating data with an external environment. Each interface of the several interfaces may be configured for communicating data with a device coupled thereto. The data management module may be configured to receive from a user a selection of an interface from the plurality of interfaces. The data management module may be further configured for routing data between the device and the external environment via the external interface and the selected interface.

In some embodiments, the data management module may be further configured to render a graphical user interface tool through which the selection of the interface is received. It is appreciated that the external interface may be configured for communicating data with the external environment via optical signals.

In some embodiments, the data communicated between the device and the external environment may belong to a first local area network (LAN) and data other than the data communicated between the device and the external environment may belong to a second, different LAN. In some embodiments, the apparatus further includes a motherboard that is configured for connecting the external interface and the several interfaces. It is appreciated that the several interfaces includes a copper-based interface integrated into the motherboard. In some embodiments, the apparatus further includes an adapter card that is configured for coupling to a motherboard interface of the motherboard.

In some embodiments, an apparatus includes an external interface, a set of interfaces, and a data management module. The external interface may be configured for communicating data with an external environment. Each interface in the set of interfaces may be configured for communicating data with a device coupled thereto. The data management module may be configured for associating an interface in the set of interfaces with the external interface when the data management module detects that the set of interfaces is a single interface. The data management module may be further configured for receiving from a user a selection of an interface in the set of interfaces for association with the external interface when the data management module detects that the set of interfaces includes at least two interfaces. The data management module may be further configured for routing data between the device and the external environment via the external interface and the associated interface.

It is appreciated that the external interface may be configured for communicating data with the external environment via optical signals. The interface associated with the external interface may be an interface in the set of interface to which the device is coupled. In some embodiments, the apparatus further includes a motherboard configured for connecting the external interface and the set of interfaces. It is appreciated that the set of interfaces includes a copper-based interface integrated into the motherboard. In some embodiments, the apparatus further includes an adapter card that is configured for coupling to a motherboard interface of the motherboard. In some embodiments, the external interface may be integrated into the adapter card.

These and various other features and advantages will be apparent from a reading of the following detailed description.

### BRIEF DESCRIPTION OF DRAWINGS

The embodiments are illustrated by way of example, and not by way of limitation, in the figures of the accompanying drawings and in which like reference numerals refer to similar elements.

FIG. 1 shows a computing device with a single electrical communication interface in accordance with some embodiments.

FIG. 2 shows a computing device with several electrical communication interfaces in accordance with some embodiments.

FIG. 3 shows a flow diagram for managing data for communication interfaces in accordance with some embodiments.

FIG. 4 shows a computer system in accordance with some embodiments.

FIG. 5 shows a block diagram of a computer system in accordance with some embodiments.

### DETAILED DESCRIPTION

Reference will now be made in detail to various embodiments, examples of which are illustrated in the accompanying drawings. While various embodiments are described herein, it will be understood that these various embodiments are not intended to limit the scope of the embodiments. On the contrary, the embodiments are intended to cover alternatives, modifications, and equivalents, which may be included within the scope of the embodiments as construed according to the appended Claims. Furthermore, in the following detailed description of various embodiments, numerous specific details are set forth in order to provide a thorough understanding of the concept. However, it will be evident to one of ordinary skill in the art that the concept may be practiced without these specific details. In other instances, well known methods, procedures, components, and circuits have not been described in detail as not to unnecessarily obscure aspects of the concept and embodiments.

Some portions of the detailed descriptions that follow are presented in terms of procedures, logic blocks, processing, and other symbolic representations of operations on data bits within a computer memory. These descriptions and representations are the means used by those skilled in the data processing arts and data communication arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities take the form of electrical or magnetic signals capable of being stored, transferred, combined, compared, and otherwise manipulated in an electronic device, a computer system or computing device. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “identifying,” “creating,” “generating,” “storing,” “retrieving,” “determining,” “sending,” “receiving,” “transmitting,” “communicating,” “providing,” “accessing,” “associating,” “disabling,” “enabling,” “configuring,” “initiating,” “starting,” “terminating,” “ending,” “configuring,” “forming,” “grouping,” “detecting,” “reverting,” “selecting,” “updating” or the like, refer to actions and processes of a computer system or similar electronic computing device or processor. The computer system or similar electronic computing device manipulates and transforms data represented as physical (electronic) quantities within the computer system memories, registers or other such information storage, transmission or display devices.

It is appreciated that present systems and methods can be implemented in a variety of architectures and configurations. For example, present systems and methods can be implemented as part of a distributed computing environment, a cloud computing environment, a client server environment, etc. Embodiments described herein may be discussed in the general context of machine-executable instructions residing on some form of machine-readable storage medium, such as program modules, executed by one or more computers, computing devices, or other devices. By way of example, and not limitation, machine-readable storage media may comprise computer storage media and communication media. Generally, program modules include routines, programs, objects, components, data structures, etc., that perform particular tasks or implement particular abstract data types. The functionality of the program modules may be combined or distributed as desired in various embodiments.

Computer storage media can include volatile and nonvolatile, removable and non-removable media implemented in any method or technology for storage of information such as machine-readable instructions, data structures, program modules, or other data. Computer storage media can include, but is not limited to, random access memory (RAM), read only memory (ROM), electrically erasable programmable ROM (EEPROM), flash memory, or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can be accessed to retrieve that information.

Communication media can embody computer-executable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared and other wireless media. Combinations of any of the above can also be included within the scope of machine-readable storage media.

Embodiments described herein are directed to computing devices that include an external communication interface (e.g., a fiber optic communication interface) and one or more electrical communication interfaces. In some embodiments, the computing device is configured to route data between a device connected to its electrical communication interface and an external environment that is coupled to the external communication interface communication interface of the computing device. In some embodiments, the computing device may detect the presence of an electrical communication interface in the computing device and may automatically configure itself to route data between the electrical communication interface and the external communication interface. In some embodiments, the computing device may detect the presence of several electrical communication interfaces in the computing device and may configure itself to route data between an electrical communication interface selected by a user and the external communication interface.

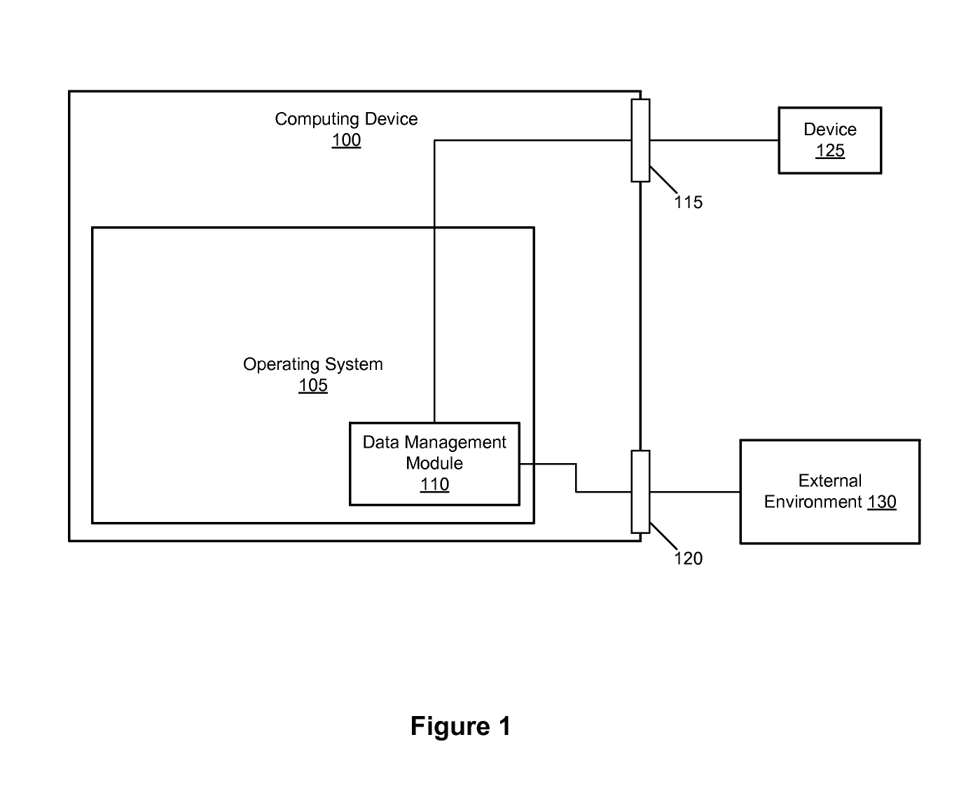

Referring now to FIG. 1, a computing device 100 with a single electrical communication interface in accordance with some embodiments is shown. In some embodiments, the computing device 100 may be a thin client device with reduced number of Peripheral Component Interconnect (PCI) slots (e.g., fewer than two PCI slots). Although many of the features are illustrated with reference to PCI slots, it is appreciated that the discussion of PCI slots is illustrative and is not intended to limit the scope of the embodiments. For example, in some embodiments, the features described herein may be applicable to thin clients with reduced number of PCI express (PCIe) slots, PCI extended (PCI-X) slots, and/or any other types of computing device expansion slots.

As shown, the computing device 100 includes an operating system 105, an electrical communication interface 115, and a fiber optic communication interface 120. As illustrated in FIG. 1, the computing device 100 is coupled to a device 125 via electrical communication interface 115 and an external environment 130 via fiber optic communication interface 120. Although FIG. 1 illustrates a few components of the computing device 100, it is appreciated that the computing device 100 may include other components (not shown) to ensure proper functionality.

The operating system 105 may be a program responsible for managing other programs running on the computing device 100. In some embodiments, the operating system 105 performs various operations (e.g., processor operations, memory operations, input operations, output operations, etc.) to manage the other programs. The operating system may be executed by at least one processor of the computing device 100. The operating system 105 may be MS-DOS®, MS-WINDOWS®, OS/2®, UNIX®, Linux®, or any other operating system.

As shown, the operating system includes a data management module 110 that is configured to manage the communication of data between the computing device 100, the device 125, and the external environment 130. In some embodiments, the data management module 110 is configured to detect a number of electrical communication interfaces in the computing device 100 and perform operations according to the number of electrical communication interfaces detected. It is appreciated that the data management module 110 may operate at a layer 2 level of the operating system 105.

In this example, the data management module 110 detects that the computing device 100 includes one electrical communication interface (the electrical communication interface 115). In response to detecting the electrical communication interface 115, the data management module 110 automatically configures itself to route data received from the device 125 at the electrical communication interface 115, and destined for the external environment 130, through the fiber optic communication interface 120. In addition, the data management module 110 automatically configures itself to route data received from the external environment 130 at the fiber optic communication interface 120, and destined for the device 125, through the electrical communication interface 115. In some embodiments, the data management module 110 automatically configures itself to perform such routing when the data management module (or another module in the operating system 110) detects a device connected to the one electrical communication interface (e.g., the device 125 connected to the electrical communication interface 115). It is appreciated that the configuration of the computing device 100 to route data between the device 125 and the external environment 130 may be performed manually (e.g., in response to user initiation) in some embodiments.

In some embodiments, data transmitted between the device 125 and the computing device 100 belong to a first layer 2 network (e.g., a local area network (LAN), a virtual LAN (VLAN), etc.) while other data (e.g., data not transmitted between the device 125 and the computing device 100) belong to a second, different layer 2 network (e.g., a LAN, a VLAN, etc.). For example, the device 125 may be a voice over Internet Protocol (VoIP) phone. In such an example, voice data transmitted between the device 125 and the computing device 100 belong to a first layer 2 network while non-voice data (e.g., data not transmitted between the device 125 and the computing device 100) belong to a second, different layer 2 network.

The electrical communication interface 115 is a communication interface that communicates with a device (e.g., the device 125) via electronic signals. For example, the electrical communication interface 115 may be an Ethernet interface in some embodiments. It is appreciated that the electrical communication interface 115 may be any number of different types of electrical communication interfaces. In some embodiments, the electrical communication interface 115 is integrated into a motherboard (not shown) included in the computing device 100. In other embodiments, the electrical communication interface 115 is integrated into an adapter card (not shown) that is coupled to the motherboard. It is appreciated that the electrical communication interface 115 may be an optical communication interface in some embodiments.

The device 125 may be any type of device that is configured to communicate with the computing device 100 via electronic signals. For instance, the device 125 may be a VoIP phone, an image capture device (e.g., a digital camera, a video camera, etc.), a network device (e.g., a switch, a network router, a wireless network router, etc.), etc.

The fiber optic communication interface 120 is a communication interface that communicates with the external environment 130 via optical signals. For example, the fiber optic communication interface 120 may be a fiber optic transceiver (e.g., a small form-factor pluggable (SFP) transceiver) in some embodiments. It is appreciated that the fiber optic communication interface 120 may be any number of different types of fiber optic communication interfaces. In some embodiments, the fiber optic communication interface 120 is integrated into a motherboard (not shown) included in the computing device 100. In other embodiments, the fiber optic communication interface 120 is integrated into an adapter card (not shown) that is coupled to the motherboard. Still, in some embodiments, the fiber optic communication interface 120 and the electrical communication interface 115 are integrated into an adapter card (not shown) that is coupled to the motherboard. The external environment 130 may be any type of environment (e.g., a computer network) that is configured to communicate with the computing device 100 via optical signals.

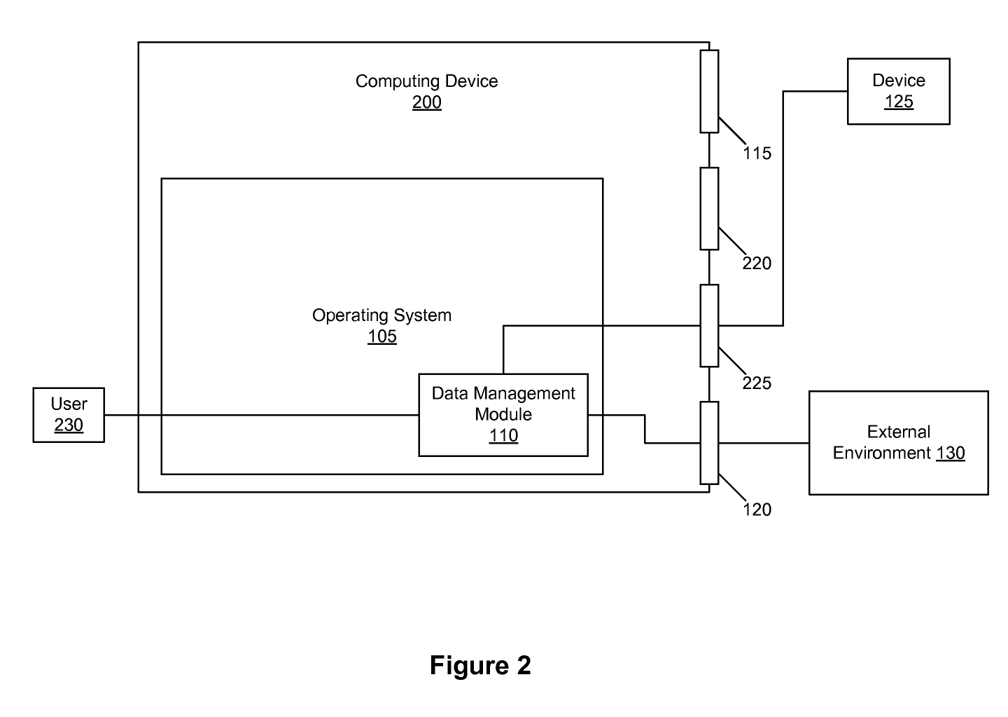

Referring now to FIG. 2, a computing device 200 with several electrical communication interfaces in accordance with some embodiments is shown. The computing device 200 is similar to the computing device 100 except that the computing device 200 also includes electrical communication interfaces 220 and 225.

The electrical communication interfaces 220 and 225 are similar to the electrical communication interface 115. That is, the electrical communication interfaces 220 and 225 are communication interfaces that are each configured to communicate with a device (e.g., the device 125) via electronic signals. For example, the electrical communication interfaces 220 and 225 may be Ethernet interfaces in some embodiments. It is appreciated that the electrical communication interfaces 220 and 225 may be any number of different types of electrical communication interfaces. In some embodiments, the electric communication interface 220 and/or the electrical communication interface 225 are integrated into a motherboard (not shown) included in the computing device 200. In other embodiments, the electrical communication interface 220 and/or the electrical communication interface 225 are integrated into an adapter card (not shown) that is coupled to the motherboard. Still, in some embodiments, the fiber optic communication interface 120 and the electrical communication interfaces 115, 220, and 225, or any combination thereof, are integrated into an adapter card (not shown) that is coupled to the motherboard. It is appreciated that the electrical communication interfaces 220 and 225 may be optical communication interfaces in some embodiments.

In some embodiments, the data management module 110 is configured to manage the communication of data between the computing device 200, the device 125, and the external environment 130. For example, the data management module 110 is configured, in some embodiments, to detect a number of electrical communication interfaces in the computing device 200 and perform operations according to the number of electrical communication interfaces detected.

In this example, the data management module 110 detects that the computing device 200 includes more than one electrical communication interfaces (e.g., the electrical communication interfaces 115, 220, and 225). In response to detecting the electrical communication interfaces 115, 220, and 225, the data management module 110 provides a user 230 with an option (e.g., a graphical user interface (GUI) option such as a drop-down menu, a pop-up menu, etc.) to select an electrical communication interface from among the electrical communication interfaces 115, 220, and 225. Upon receiving a selection of an electrical communication interface from the user 230, the data management module 110 configures itself to route data received from a device at the selected electrical communication interface, and destined for the external environment 130, through the fiber optic communication interface 120. Additionally, the data management module 110 configures itself to route data received from the external environment 130 at the fiber optic communication interface 120, and destined for the device 125, through the selected electrical communication interface.

As shown in FIG. 2, the device 125 is connected to the electrical communication interface 225. As such, the user 230 for this example selects the electrical communication interface 225 through the option provided by the data management module 110. In response to the selection of the electrical communication interface 225, the data management module 110 configures itself to route data received from the device 125 at the electrical communication interface 225, and destined for the external environment 130, through the fiber optic communication interface 120. The data management module 110 also configures itself to route data received from the external environment 130 at the fiber optic communication interface 120, and destined for the device 125, through the electrical communication interface 225. In some embodiments, the computing device 200 provides an error message when the user selects an electrical communication interface to which the device 125 is not coupled. In some embodiments, the computing device 100 automatically selects the correct electrical communication interface and configures itself to route data between the correct electrical communication interface and the fiber optic communication interface 120.

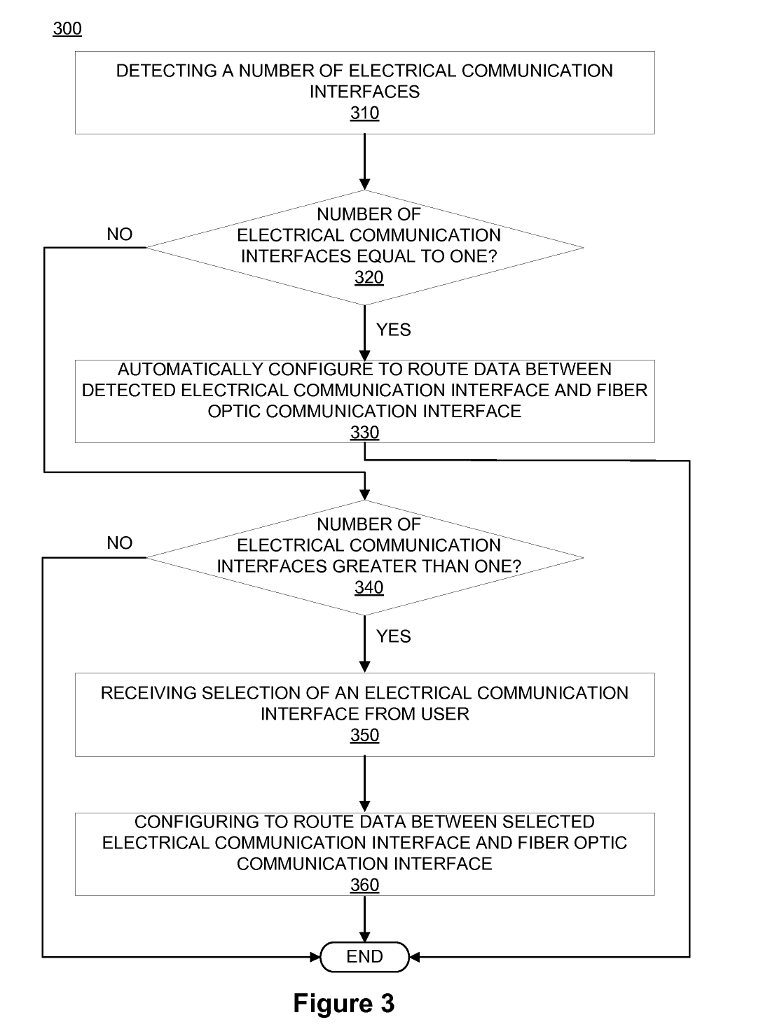

FIG. 3 shows a flow diagram 300 for managing data for communication interfaces in accordance with some embodiments. In some embodiments, a computing device (e.g., the computing device 100, the computing device 200, etc.) performs the operations described in FIG. 3 as part of the boot up process of an operating system (e.g., the operating system 105) executing on the computing device. At step 310, the computing device detects a number of electrical communication interfaces in the computing device.

At step 320, the computing device determines whether the number of detected electrical communication interfaces is one. If so, the computing device automatically configures itself at step 330 to route data between the detected electrical communication interface and a fiber optic interface of the computing device. Otherwise, the computing device proceeds to step 340.

At step 340, the computing device determines whether the number of detected electrical communication interfaces is greater than one. If the computing device determines that the number of detected electrical communication interfaces is greater than one, the computing device provides an option to a user for selecting an electrical communication interface. Next, the computing device receives a selection of an electrical communication interface from the user at step 350. Then, the computing device configures itself at step 360 to route data between the selected electrical communication interface and the fiber optic interface of the computing device.

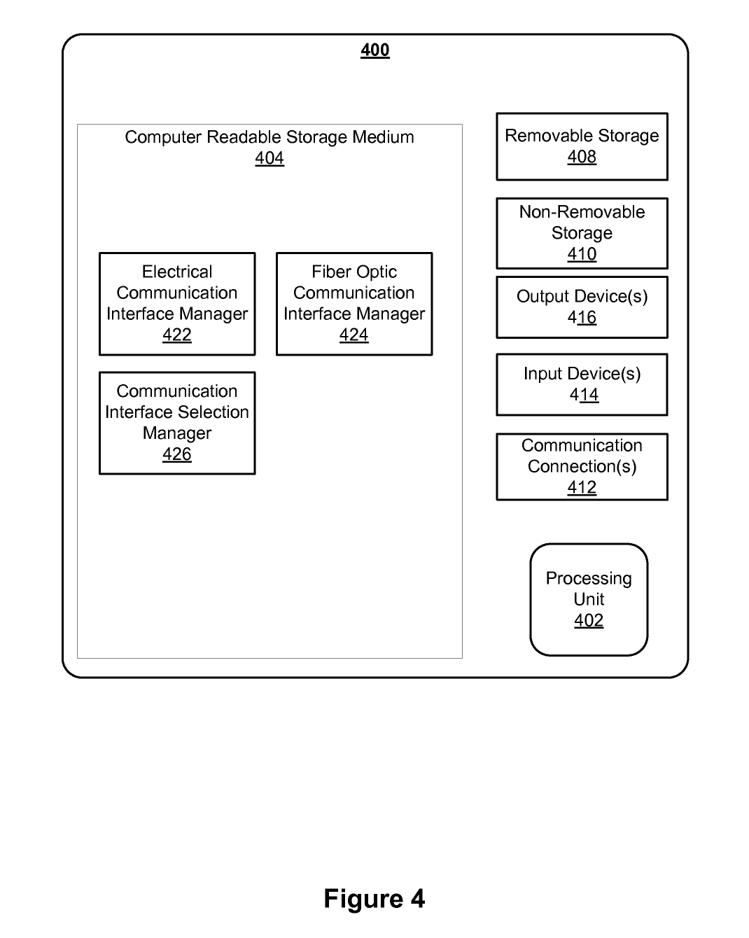

Referring now to FIG. 4, a block diagram of a computer system in accordance with some embodiments is shown. With reference to FIG. 4, a system module for implementing embodiments includes a general purpose computing system environment, such as computing system environment 400. Computing system environment 400 may include, but is not limited to, servers, switches, routers, desktop computers, laptops, tablets, mobile devices, and smartphones. In its most basic configuration, computing system environment 400 typically includes at least one processing unit 402 and machine readable storage medium 404. Depending on the exact configuration and type of computing system environment, machine readable storage medium 404 may be volatile (such as RAM), non-volatile (such as ROM, flash memory, etc.) or some combination of the two. Portions of machine readable storage medium 404 when executed facilitate the forwarding/routing of network data through a management network, the management of backup data of nodes in the management network, the restoration of such nodes based on the backup data, the distribution of special link configuration information, and establishing special links based on the special link configuration information.

Additionally, in various embodiments, computing system environment 400 may also have other features/functionality. For example, computing system environment 400 may also include additional storage (removable and/or non-removable) including, but not limited to, magnetic or optical disks or tape. Such additional storage is illustrated by removable storage 408 and non-removable storage 410. Computer storage media includes volatile and nonvolatile, removable and non-removable media implemented in any method or technology for storage of information such as machine readable instructions, data structures, program modules or other data. Machine readable medium 404, removable storage 408 and nonremovable storage 410 are all examples of computer storage media. Computer storage media includes, but is not limited to, RAM, ROM, EEPROM, flash memory or other memory technology, expandable memory (e.g., USB sticks, compact flash cards, SD cards), CD-ROM, digital versatile disks (DVD) or other optical storage, magnetic cassettes, magnetic tape, magnetic disk storage or other magnetic storage devices, or any other medium which can be used to store the desired information and which can be accessed by computing system environment 400. Any such computer storage media may be part of computing system environment 400.

In some embodiments, computing system environment 400 may also contain communications connection(s) 412 that allow it to communicate with other devices. Communications connection(s) 412 is an example of communication media. Communication media typically embodies machine readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term machine readable media as used herein includes both storage media and communication media.

Communications connection(s) 412 may allow computing system environment 400 to communicate over various networks types including, but not limited to, fibre channel, small computer system interface (SCSI), Bluetooth, Zigbee, Z-Wave, Ethernet, Wi-fi, Infrared Data Association (IrDA), Local area networks (LAN), Wireless Local area networks (WLAN), wide area networks (WAN) such as the internet, serial, and universal serial bus (USB). It is appreciated the various network types that communication connection(s) 412 connect to may run a plurality of network protocols including, but not limited to, transmission control protocol (TCP), user datagram protocol (UDP), internet protocol (IP), real-time transport protocol (RTP), real-time transport control protocol (RTCP), file transfer protocol (FTP), and hypertext transfer protocol (HTTP).

In further embodiments, computing system environment 400 may also have input device(s) 414 such as keyboard, mouse, a terminal or terminal emulator (either connected or remotely accessible via telnet, SSH, http, SSL, etc.), pen, voice input device, touch input device, remote control, etc. Output device(s) 416 such as a display, a terminal or terminal emulator (either connected or remotely accessible via telnet, SSH, http, SSL, etc.), speakers, light emitting diodes (LEDs), etc. may also be included. All these devices are well known in the art and are not discussed at length.

In one embodiment, machine readable storage medium 404 includes an electrical communication interface manager module 422, a fiber optic communication interface manager module 424, and a communication interface selection module 426. The electrical communication interface manager module 422 is operable to handle detection of data electrical communication interfaces, communication of data through electrical communication interfaces, and configuration of electrical communication interfaces according to flow diagram 300, for instance. The fiber optic communication interface manager module 424 may be used for communication of data through fiber optic communication interfaces and configuration of electrical communication interfaces according to flow diagram 300, for instance. The communication interface selection module 426 operates to provide an option to a user for selecting an electrical communication interface according to flow diagram 300, for instance.

It is appreciated that implementations according to some embodiments that are described with respect to a computer system are merely exemplary and not intended to limit the scope of the embodiments. For example, some embodiments may be implemented on devices such as switches and routers, which may contain application specific integrated circuits (ASICs), field programmable gate arrays (FPGAs), etc. It is appreciated that these devices may include a machine readable medium for storing instructions for implementing methods according to flow diagrams 500 and 600.

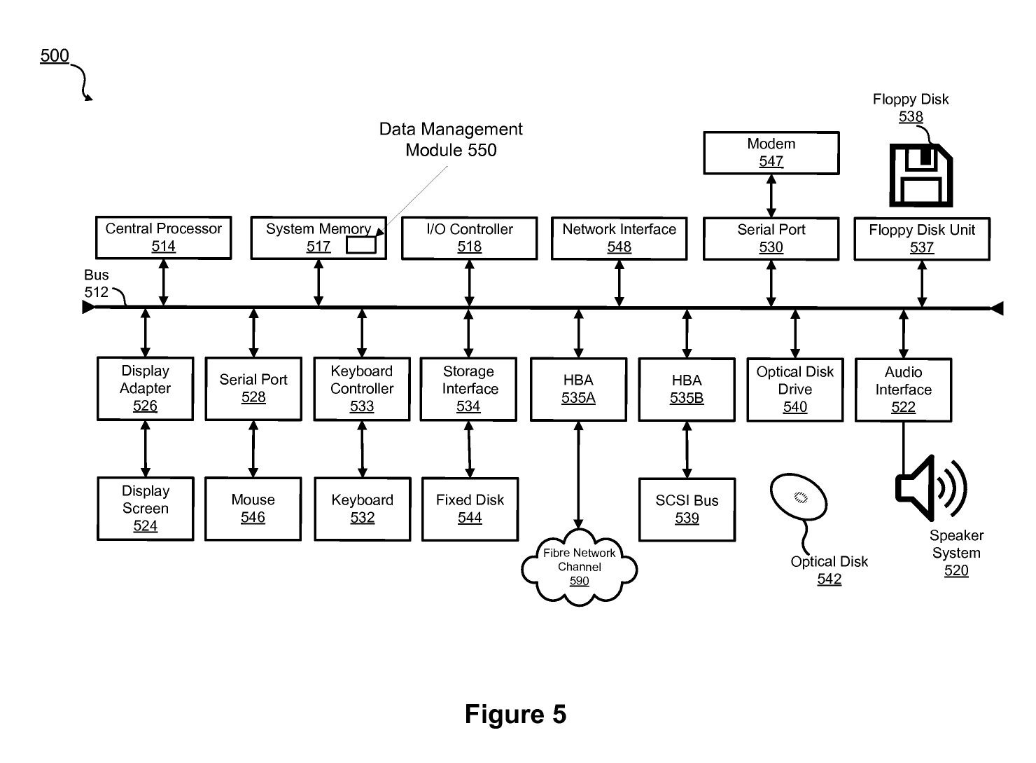

Referring now to FIG. 5, a block diagram of another exemplary computer system in accordance with some embodiments is shown. FIG. 5 depicts a block diagram of a computer system 510 suitable for implementing the present disclosure. Computer system 510 includes a bus 512 which interconnects major subsystems of computer system 510, such as a central processor 514, a system memory 517 (typically RAM, but which may also include ROM, flash RAM, or the like), an input/output controller 518, an external audio device, such as a speaker system 520 via an audio output interface 522, an external device, such as a display screen 524 via display adapter 526, serial ports 528 and 530, a keyboard 532 (interfaced with a keyboard controller 533), a storage interface 534, a floppy disk drive 537 operative to receive a floppy disk 538, a host bus adapter (HBA) interface card 535A operative to connect with a Fibre Channel network 590, a host bus adapter (HBA) interface card 535B operative to connect to a SCSI bus 539, and an optical disk drive 540 operative to receive an optical disk 542. Also included are a mouse 546 (or other point-and-click device, coupled to bus 512 via serial port 528), a modem 547 (coupled to bus 512 via serial port 530), and a network interface 548 (coupled directly to bus 512). It is appreciated that the network interface 548 may include one or more Ethernet ports, wireless local area network (WLAN) interfaces, Bluetooth interfaces, Zigbee interfaces, Z-Wave interfaces, etc., but are not limited thereto. System memory 517 includes a data management module 550 which is operable to manage data communication for communication interfaces. According to one embodiment, the data management module 550 may include other modules for carrying out various tasks. For example, the data management module 550 may include the electrical communication interface manager module 422, the fiber optic communication interface manager module 424, and the communication interface selection module 426, as discussed with respect to FIG. 4 above. It is appreciated that the data management module 550 may be located anywhere in the system and is not limited to the system memory 517. As such, residing of the data management module 550 within the system memory 517 is merely exemplary and not intended to limit the scope of the embodiments. For example, parts of the data management module 550 may reside within the central processor 514 and/or the network interface 548 but are not limited thereto.

Bus 512 allows data communication between central processor 514 and system memory 517, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with computer system 510 are generally stored on and accessed via a machine readable medium, such as a hard disk drive (e.g., fixed disk 544), an optical drive (e.g., optical drive 540), a floppy disk unit 537, or other storage medium. Additionally, applications can be in the form of electronic signals modulated in accordance with the application and data communication technology when accessed via network modem 547 or interface 548.

Storage interface 534, as with the other storage interfaces of computer system 510, can connect to a standard machine readable medium for storage and/or retrieval of information, such as a fixed disk drive 544. Fixed disk drive 544 may be a part of computer system 510 or may be separate and accessed through other interface systems. Network interface 548 may provide multiple connections to other devices. Furthermore, modem 547 may provide a direct connection to a remote server via a telephone link or to the Internet via an internet service provider (ISP). Network interface 548 may provide one or more connection to a data network, which may include any number of networked devices. It is appreciated that the connections via the network interface 548 may be via a direct connection to a remote server via a direct network link to the Internet via a POP (point of presence). Network interface 548 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., document scanners, digital cameras and so on). Conversely, all of the devices shown in FIG. 5 need not be present to practice the present disclosure. The devices and subsystems can be interconnected in different ways from that shown in FIG. 5. The operation of a computer system such as that shown in FIG. 5 is readily known in the art and is not discussed in detail in this application. Code to implement the present disclosure can be stored in machine-readable storage media such as one or more of system memory 517, fixed disk 544, optical disk 542, or floppy disk 538. The operating system provided on computer system 510 may be MS-DOS®, MS-WINDOWS®, OS/2®, UNIX®, Linux®, or any other operating system.

Moreover, regarding the signals described herein, those skilled in the art will recognize that a signal can be directly transmitted from a first block to a second block, or a signal can be modified (e.g., amplified, attenuated, delayed, latched, buffered, inverted, filtered, or otherwise modified) between the blocks. Although the signals of the above described embodiment are characterized as transmitted from one block to the next, other embodiments of the present disclosure may include modified signals in place of such directly transmitted signals as long as the informational and/or functional aspect of the signal is transmitted between blocks. To some extent, a signal input at a second block can be conceptualized as a second signal derived from a first signal output from a first block due to physical limitations of the circuitry involved (e.g., there will inevitably be some attenuation and delay). Therefore, as used herein, a second signal derived from a first signal includes the first signal or any modifications to the first signal, whether due to circuit limitations or due to passage through other circuit elements which do not change the informational and/or final functional aspect of the first signal.

The foregoing description, for purpose of explanation, has been described with reference to specific embodiments. However, the illustrative discussions above are not intended to be exhaustive or to limit the embodiments disclosed. Many modifications and variations are possible in view of the above teachings.

What is claimed is:

1. An apparatus comprising:
a first interface configured for communicating data with a device coupled to the first interface;
a second interface configured for communicating data with an external environment of the apparatus, wherein the first interface is different from the second interface; and
a data management module configured for routing data between the device and the external environment via the first and second interfaces upon detecting that the device is coupled to the first interface.

2. The apparatus as described in claim 1 further comprising a motherboard configured for connecting the first and second interfaces, wherein the first interface is a copper-based interface integrated into the motherboard.

3. The apparatus as described in claim 1 further comprising:
a motherboard configured for connecting the first and second interfaces; and
an adapter card configured for coupling to a motherboard interface of the motherboard,
wherein the first interface includes a copper-based interface integrated into the adapter card.

4. The apparatus as described in claim 1, wherein the data communicated between the device and the external environment belongs to a first local area network (LAN), wherein data other than the data communicated between the device and the external environment belongs to a second, different LAN.

5. The apparatus as described in claim 1, wherein the data management module is further configured for operating at a layer 2 level of an operating system configured for executing on the apparatus.

6. The apparatus as described in claim 1, wherein the second interface is further configured for communicating data with the external environment via optical signals.

7. The apparatus as described in claim 1, wherein the device is configured for communicating voice data with the external environment.

8. The apparatus as described in claim 7, wherein the external environment includes a network.

9. An apparatus comprising:
an external interface configured for communicating data with an external environment;
a plurality of interfaces, wherein each interface of the plurality of interfaces is configured for communicating data with a device coupled thereto; and
a data management module is configured to receive from a user a selection of an interface from the plurality of interfaces,
wherein the data management module is further configured for routing data between the device and the external environment via the external interface and the selected interface.

10. The apparatus as described in claim 9, wherein the data management module is further configured to render a graphical user interface tool through which the selection of the interface is received.

11. The apparatus as described in claim 9, wherein the external interface is configured for communicating data with the external environment via optical signals.

12. The apparatus as described in claim 9, wherein the data communicated between the device and the external environment belongs to a first local area network (LAN), wherein data other than the data communicated between the device and the external environment belongs to a second, different LAN.

13. The apparatus as described in claim 9 further comprising a motherboard configured for connecting the external interface and the plurality of interfaces, wherein the plurality of interfaces includes a copper-based interface integrated into the motherboard.

14. The apparatus as described in claim 9 further comprising:
a motherboard configured for connecting the external interface and the plurality of interfaces; and
an adapter card configured for coupling to a motherboard interface of the motherboard,
wherein the plurality of interfaces includes a copper-based interface integrated into the adapter card.

15. An apparatus comprising:
an external interface configured for communicating data with an external environment;
a set of interfaces, wherein each interface in the set of interfaces is configured for communicating data with a device coupled thereto; and
a data management module configured for associating an interface in the set of interfaces with the external interface when the data management module detects that the set of interfaces is a single interface,
wherein the data management module is further configured for receiving from a user a selection of an interface in the set of interfaces for association with the external interface when the data management module detects that the set of interfaces includes at least two interfaces,
wherein the data management module is further configured for routing data between the device and the external environment via the external interface and the associated interface.

16. The apparatus as described in claim 15, wherein the external interface is configured for communicating data with the external environment via optical signals.

17. The apparatus as described in claim 15, wherein the interface associated with the external interface is an interface in the set of interface to which the device is coupled.

18. The apparatus as described in claim 15 further comprising a motherboard configured for connecting the external interface and the set of interfaces, wherein the set of interfaces includes a copper-based interface integrated into the motherboard.

19. The apparatus as described in claim 15 further comprising:
a motherboard configured for connecting the external interface and the set of interfaces; and
an adapter card configured for coupling to a motherboard interface of the motherboard,
wherein the set of interfaces includes a copper-based interface integrated into the adapter card.

20. The apparatus as described in claim 19, wherein the external interface is integrated into the adapter card.
